(19) United States
(12) Patent Application Publication
(10) Pub. No.: US 2012/0226580 A1
(43) Pub. Date: Sep. 6, 2012

(54) GIFT TRANSACTIONS VIA A CLIENT DEVICE

(75) Inventor: Sandhya Raghavan, Velachery (IN)

(73) Assignee: eBay, Inc., San Jose, CA (US)

(21) Appl. No.: 13/039,880

(22) Filed: Mar. 3, 2011

(51) Int. Cl. G06Q 30/00

(52) U.S. Cl. 705/26.41

(57) ABSTRACT

Methods and systems according to one or more embodiments enable a user to easily send gifts via a client device, for example, a mobile device. In one embodiment, a method comprises receiving, by a server at a remote location, from a user via a client device, an order selecting one or more items and/or services to be sent to a recipient along with a recipient's identifier that is entered by the user on the client device, wherein the recipient's identifier is used to determine delivery information of the recipient. The method also comprises sending, by the server at the remote location, the recipient's identifier to a merchant server for fulfillment of the order. The method further comprises receiving, by the server at the remote location, confirmation of the order from the user via the client device.

### BACKGROUND

1. Technical Field

Embodiments of the present disclosure generally relate to transactions, and more particularly, to methods and systems for transactions involving sending gifts via a client device.

2. Related Art

In electronic commerce, a customer routinely searches for, purchases and pays for products and/or services from online merchants over communication networks, such as the Internet. In this regard, individual customers may frequently engage in transactions with a variety of merchants through, for example, various merchant websites. Routinely, customers engage in such transactions by using their mobile device. In particular, customers may wish to select products and/or services for sending as gifts for special occasions such as Birthdays, Anniversaries, Christmas, etc. However, typical ways of sending gifts and making payments over the Internet may be cumbersome and inconvenient especially when using a mobile device. For example, sending gifts and making payments over a network may require the customer to fill in multiple lines of information such as a recipient's name, shipping information, method of payment, etc. Entering such information on a mobile device may be particularly cumbersome. Accordingly, there is a need for a simple way of sending gifts and making payments using a mobile device with minimal key entries.

### SUMMARY

As will be further described herein in relation to various embodiments, methods and systems for transactions conducted via a client device are provided, allowing a user to send gifts and make payments for purchases and/or services in a simple way with minimal key entries.

In accordance with an embodiment of the disclosure, a method for gift transactions comprises receiving, by a server at a remote location, from a user via a client device, an order selecting one or more items and/or services to be sent to a recipient along with a recipient's identifier that is entered by the user on the client device, wherein the recipient's identifier is used to determine delivery information of the recipient. The method also comprises sending, by the server at the remote location, the recipient's identifier to a merchant server for fulfillment of the order. The method further comprises receiving, by the server at the remote location, confirmation of the order from the user via the client device.

In accordance with another embodiment of the disclosure, a gift system includes a payment provider server in communication with a client device and a merchant server over a network; one or more processors; and one or more memories adapted to store a plurality of machine-readable instructions which when executed by the one or more processors are adapted to cause the gift system to: receive, by the payment provider server, an order selecting one or more items and/or services from a user over the client device to be sent to a recipient along with a recipient's identifier that is entered by the user on the client device, wherein the recipient's identifier is used to determine delivery information of the recipient; send, by the payment provider server, the recipient's identifier to a merchant server for fulfillment of the order; and receive, by the payment provider server, confirmation of the order from the user via the client device.

In accordance with another embodiment of the disclosure, a client device comprises: a user interface; a gift application loaded in the client device from a service provider server; one or more processors; and one or more memories adapted to store a plurality of machine-readable instructions which when executed by the one or more processors are adapted to cause the client device to: receive, via the user interface, inputs for a gift transaction comprising selection of one or more items and/or services to be sent to a recipient as a gift and a recipient's identifier, wherein the recipient identifier is used to determine delivery information of the recipient; transmit information of the gift transaction to a payment provider server, wherein the payment provider server sends the recipient's identifier to a merchant server for fulfillment of the gift transaction; and confirm the information of the gift transaction.

In accordance with another embodiment of the disclosure, a non-transitory computer readable medium on which are stored computer readable instructions and, when executed by a processor, cause the processor to: receive, by a payment provider server, an order selecting one or more items and/or services from a user over a client device to be sent to a recipient along with a recipient's identifier that is entered by the user on the client device, wherein the recipient's identifier is used to determine delivery information of the recipient; send, by the payment provider server, the recipient's identifier to a merchant server for fulfillment of the order; and receive, by the payment provider server, confirmation of the order from the user via the client device.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 is a block diagram of a gift system using a service provider according to an embodiment of the present disclosure.

FIG. 2 is a flow chart illustrating a method for conducting a transaction involving sending a gift using a client device according to an embodiment of the present disclosure.

FIGS. 3-5 illustrate a user interface of a client device at different stages of a process for sending a gift according to one or more embodiments of the present disclosure.

FIG. 6 is a block diagram of a system for implementing a device according to one embodiment of the present disclosure.

Like element numbers in different figures represent the same or similar elements.

### DETAILED DESCRIPTION

In accordance with various embodiments described herein, methods and systems are provided that enable a user to easily select and send gifts to a recipient over a client device, for example, customized gifts with predefined items in view of special occasions, and make payments for the selected gifts over the client device.

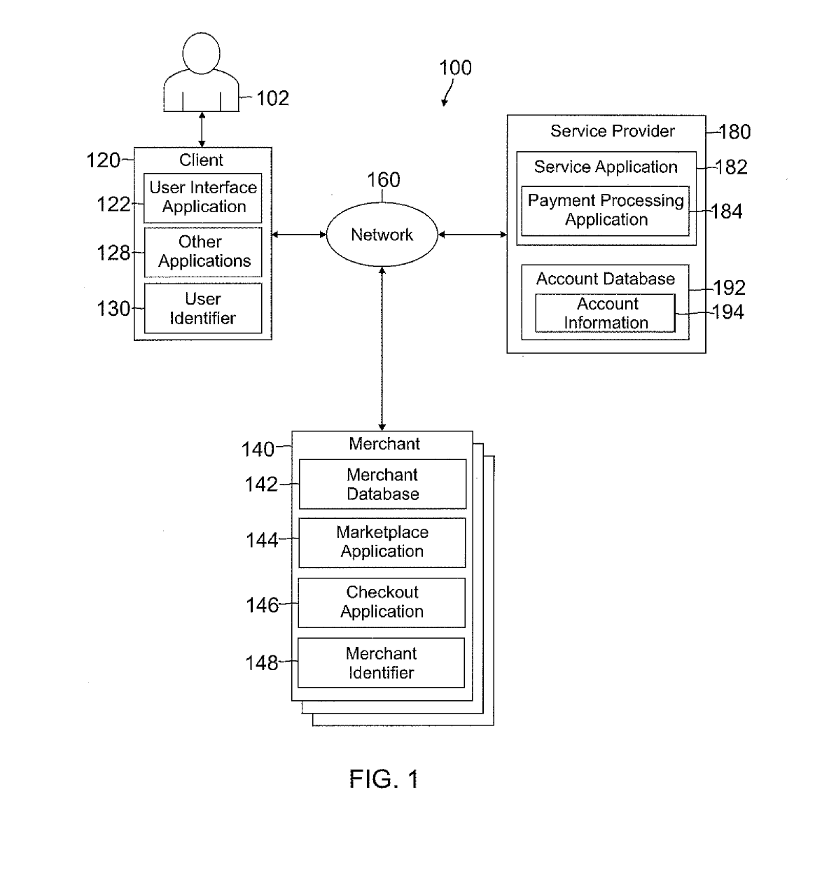

Referring now to the drawings wherein the showings are for purposes of illustrating embodiments of the present disclosure only, and not for purposes of limiting the same, FIG. 1 illustrates a block diagram of a gift system using a service provider according to an embodiment of the present disclosure.

FIG. 1 shows one embodiment of a block diagram of a system 100 adapted to facilitate transactions involving sending gifts via a client device 120 over a network 160. As shown in FIG. 1, the system 100 includes at least one client device 120 (e.g., network computing device), one or more merchant servers or devices 140 (e.g., network server devices), and at least one service provider server or device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the client device 120, merchant servers or devices 140, and service provider server or device 180 may be associated with a particular link (e.g., a link, such as a URL (Uniform Resource Locator) to an IP (Internet Protocol) address).

The client device 120, in various embodiments, may be implemented using any appropriate combination of hardware and/or software configured for wired and/or wireless communication over the network 160. In various examples, the client device 120 may be implemented as a wireless telephone (e.g., cellular or mobile phone), a smart phone, a personal digital assistant (PDA), a personal computer, a notebook computer, and/or various other generally known types of wired and/or wireless computing devices. Other examples of client device 120 may include a television set, a game console, a Digital Video Recorder (DVR), and potentially other devices such as microwaves, refrigerators, washing machines, etc. It should be appreciated that the client device 120 may be referred to as a user device or a customer device without departing from the scope of the present disclosure.

The client device 120, in one embodiment, includes a user interface application 122, which may be utilized by a user 102 to conduct financial transactions (e.g., shopping, purchasing, bidding, etc.) with the service provider server 180 over the network 160. In one aspect, purchase expenses may be directly and/or automatically debited from an account related to the user 102 via the user interface application 122, in a manlier as described herein.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, the user 102 is able to access merchant websites via the one or more merchant servers 140 to view and select items and/or services for purchase, and the user 102 is able to purchase items and/or services from the one or more merchant servers 140 via the service provider server 180. Accordingly, user 102 may conduct financial transactions (e.g., purchase and provide payment for items and/or services) from the one or more merchant servers 140 via the service provider server 180.

The client device 120, in various embodiments, may include other applications 128 as may be desired in one or more embodiments of the present disclosure to provide additional features available to the user 102. In one example, such other applications 128 may include security applications for implementing client-side security features, programmatic client applications for interfacing with appropriate application programming interfaces (APIs) over the network 160, and/or various other types of generally known programs and/or software applications. In still other examples, the other applications 128 may interface with the user interface application 122 for improved efficiency and convenience.

According to one or more embodiments, the user interface application 122 or the other applications 128 include an application that may be loaded on client device 120 by service provider server 180 that enables user 102 to easily select and pay for items and/or services over client device 120 to be sent as gifts as will be described herein in further detail.

The client device 120, in one embodiment, may include at least one user identifier 130, which may be implemented, for example, as operating system registry entries, cookies associated with the user interface application 122, identifiers associated with hardware of the client device 120, or various other appropriate identifiers. The user identifier 130 may include one or more attributes related to the user 102, such as personal information related to the user 102 (e.g., one or more user names, passwords, photograph images, biometric IDs, addresses, phone numbers, etc.), banking information and/or funding sources (e.g., one or more banking institutions, credit card issuers, user account numbers, security data and information, etc.) and user transaction data (e.g., usual purchased items and/or services, networking or contacts data, usual location of user, amount of purchases, time of purchases, etc.). In various implementations, the user identifier 130 may be passed with a user login request to the service provider server 180 via the network 160, and the user identifier 130 may be used by the service provider server 180 to associate the user 102 with a particular user account maintained by the service provider server 180 in a manner as described herein.

The one or more merchant servers 140, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items and/or services for purchase and payment. In some embodiments, business entities may need registration of the user identity information as part of offering the items and/or services to the user 102 over the network 160. As such, each of the one or more merchant servers 140 may include a merchant database 142 for identifying available items and/or services, which may be made available to the client device 120 for viewing and purchase by the user 102. It should be appreciated that although a user-merchant transaction is illustrated in this embodiment, the system may also be applicable to user-user, merchant-merchant and/or merchant-user transactions.

Each of the merchant servers 140, in one embodiment, may include a marketplace application 144, which may be configured to provide information over the network 160 to the user interface application 122 of the client device 120. For example, the user 102 may interact with the marketplace application 144 through the user interface application 122 over the network 160 to search and view various items and/or services available for purchase in the merchant database 142.

Each of the merchant servers 140, in one embodiment, may include a checkout application 146, which may be configured to facilitate online financial transactions (e.g., purchase transactions) by the user 102 of items and/or services identified by the marketplace application 144. As such, in one aspect, the checkout application 146 may be configured to accept payment information from the user 102 over the network 160.

Each of the merchant servers 140, in one embodiment, may include at least one merchant identifier 148, which may be included as part of the one or more items and/or services made available for purchase so that, e.g., particular items and/or services are associated with particular merchants. In one implementation, the merchant identifier 148 may include one or more attributes and/or parameters related to the merchant, such as business and banking information. In some implementations, the user 102 may conduct financial transactions (e.g., selection, monitoring, purchasing, and/or providing payment for items and/or services) with each merchant server 140 via the service provider server 180 over the network 160.

The service provider server 180, in one embodiment, may be maintained by a transaction processing entity, which may provide processing for financial transactions and/or information transactions between the user 102 and one or more of the merchant servers 140. As such, the service provider server 180 includes a service application 182, which may be adapted to interact with each client device 120 and/or each merchant server 140 over the network 160 to facilitate the selection, purchase, and/or payment of items and/or services by the user 102 from one or more of the merchant servers 140. In one example, the service provider server 180 may be provided by PayPal, Inc. and/or eBay, Inc. of San Jose, Calif., USA.

The service application 182, in one embodiment, utilizes a payment processing module 184 to process purchases and/or payments for financial transactions between the user 102 and each of the merchant servers 140. In one implementation, the payment processing module 184 assists with resolving financial transactions through validation, delivery, and settlement. As such, the service application 182 in conjunction with the payment processing module 184 settles indebtedness between the user 102 and each of the merchants 140, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 140). For example, account information 194 may include private financial information of each user 102 and each merchant associated with the one or more merchant servers 140, such as one or more account numbers, passwords, credit card information, banking information, or other types of financial information, which may be used to facilitate financial transactions between the user 102 and the one or more merchants associated with the merchant servers 140. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and the user 102 may have credentials to authenticate or verify identity with the service provider server 180. User attributes may include personal information, banking information and/or funding sources as previously described. In various aspects, the user attributes may be passed to the service provider server 180 as part of a login, selection, purchase, and/or payment request, and the user attributes may be utilized by the service provider server 180 to associate the user 102 with one or more particular user accounts maintained by the service provider server 180.

The payment system described above with respect to the embodiment of FIG. 1 may be used to facilitate transactions involving sending gifts via a client device as will be described in more detail herein.

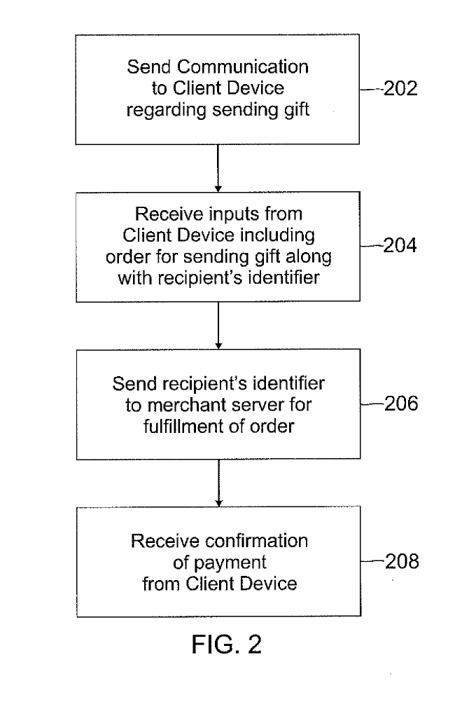

Referring now to FIG. 2, a flow chart for conducting a transaction involving sending a gift using a client device is illustrated according to an embodiment of the present disclosure. The flow chart of FIG. 2 may be implemented by the system of FIG. 1 described above according to one or more embodiments.

In block 202, when user 102 (referring also to FIG. 1) has a pre-existing user account with service provider server 180 wherein user 102 has identity attributes stored with service provider server 180 as described above, user 102 may receive communications from service provider server 180 regarding sending items and/or services as gifts to one or more recipients.

In one embodiment, service provider server 180 may send such communications to one or more users including user 102 on a regular basis, for example, on a monthly or bi-monthly basis, or as often as service provider server 180 may deem appropriate. In another embodiment, service provider server 180 may send such communications to users based on each individual user's data, profile or other user attributes, or based on particular special occasions such as Christmas.

In yet another embodiment, service provider server 180 may conduct marketing campaigns through communications to users over their client devices for sending customized gifts of predefined items, for example, particular items and/or services from particular business entities that may be sent as gifts for special occasions to one or more recipients.

Advantageously, service provider server 180 may leverage its maintained database of user data including user accounts having user information such as value or balance in the users' accounts to proactively market a campaign by sending communications to users over their client devices. For example, based on particular users' data such as a high value or high money balance, service provider server 180 may target such high balance users to offer them or market a customized gift service. Thus, such customized gift service may be beneficial to a service provider (i.e., having service provider server 180) in leveraging its existing network or database. Also, such customized gift service may be beneficial to business entities (i.e., having merchant server 140) because transactions, and therefore revenue stream, may be increased as users respond to the targeted marketing for transactions involving sending gifts via users' client devices.

Service provider server 180 may send the communication(s) to client device 120 in various forms, including for example, a text (Short Message Service (SMS)), an email, a pop-up window, etc. or any other suitable form of communication over a client device. As described above, in one embodiment, the communication(s) sent by service provider server 180 may include a message received on client device 120 for sending a customized gift of predefined items, for example, a gift box including chocolates, cakes and cookies from a specific merchant for a specific payment amount. Gifts may be sent for any occasion such as Birthdays, Anniversaries, Christmas, etc. As such, items and/or services may be suggested by service provider server 180 to the user to be sent as gifts. In other embodiments, items and/or services may be readily available to the user for quick selection and shipping, for example, items and/or services may be stored or kept as favorites on the user's client device. User 102 may then decide to place an order to purchase a selected item and/or service to be sent as a gift to a recipient.

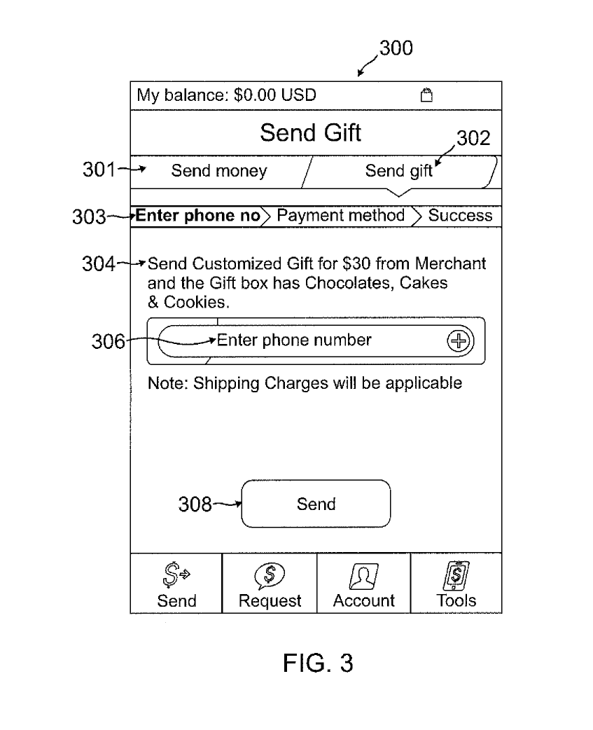

In block 204, once user 102 decides to place the order to purchase and send the selected item and/or service as a gift to a recipient, user 102 also inputs a recipient identifier, for example, a phone number of the person to whom the gift is to be sent as illustrated in FIG. 3, which will be described in more detail below according to an embodiment. User 102 may login via a login screen by entering, for example, a Username and Password to access his or her pre-existing account with service provider server 180.

In block 206, service provider server 108 may send the recipient's identifier to merchant server 140 for processing and fulfillment of the order placed over client device 120. Merchant server 140 may calculate the total amount for the selected items and/or services to be sent as a gift and sends the gift to the recipient.

In general, the recipient's identifier may be used to determine a recipient's delivery information including, for example, information for delivering to a physical shipping address or electronically. In an embodiment, the recipient identifier may be associated with a recipient's identification information, including, for example, the recipient's name and shipping information. As such, payment provider server 108 may confirm the recipient's delivery information or the recipient's identification information details based on the received recipient's identifier. It should be noted that the recipient's identifier may be, in addition or instead of a recipient's phone number, a recipient's password, identification number, code, name, address, driver's license number, or any other suitable identifier.

Advantageously, user 102 may easily conduct gift transactions over a client device with minimal key entries because user 102 may only need to enter or input the recipient's identifier (other than payment information), which may in turn be used by service provider server 108 and/or merchant server 140 to identify the recipient and the corresponding delivery information, e.g., a shipping address, for the gift order. In one embodiment, a recipient's delivery information such as a shipping address, electronic address, or other contact information may be obtained from specific service providers by utilizing their database leveraging the service provider's API's. For example, access to the specific service providers' database may be obtained for a fee depending on the nature of any terms and conditions under a contract with the service provider. In other examples, access may be obtained free of cost if the information is publicly available. It is also possible that the recipient's delivery information such as shipping address or other contact information may be obtained by contacting the recipient.

Optionally, the recipient may confirm shipment or receipt of the gift. Notably, the recipient may or may not have an account with service provider server 180.

In block 208, user 102 may review and confirm the purchase and payment details. According to one or more embodiments, user 102 may easily make payments over client device 120 by first entering credentials for authentication with respect to the user's account with service provider server 180. Once authenticated, the user may select one or various options to effect a payment. For example, user 102 may decide to have the appropriate total payment amount for the selected items and/or services deducted from the user's account as maintained by service provider server 180. That is, in an embodiment, user 102 may provide user account information and confirmation to service provider server 180 for correctly debiting the user's account towards the items and/or services provided by the merchant and/or the service provider based on the user's account balance. Also, a transaction card such as a credit card or any other type of payment may be used depending on the availability of the required payment amount. Upon review and confirmation of the purchase and payment details, user 102 may complete payment and the gift transaction may be finalized.

Referring now to FIGS. 3-5, a user interface of a client device at different stages of a process for sending a gift is illustrated according to an embodiment of the present disclosure. Client device 120 of FIG. 1 may include a user interface as illustrated in FIGS. 3-5 according to an embodiment. 1004611 As described above, user 102 may decide to purchase and send a selected item and/or service as a gift to a recipient. In the embodiment of FIG. 3, user interface 300 has a screen 301 illustrating a view of a process in a mode or a stage indicated as “Send gift” by reference number 302. In this view, screen 301 of user interface 300 shows an option for user 102 to send a customized gift with predefined items for a specified amount. In particular, as indicated by reference number 304, user 102 is given the option to “Send Customized Gift for $30 from Merchant and the Gift box has Chocolates, Cakes & Cookies.” It should be understood that countless other customized gifts with predefined items at different price points from different reputable business entities may be available to user 102. Other examples of customized gifts include “Send Flowers for $25 from Flower Merchant,” or “Send Chocolates for $25 from Chocolate Merchant,” and so on.

When user 102 decides to send the customized gift (e.g., as indicated by reference number 304) to a recipient, user 102 enters or inputs a recipient's identifier, for example, a phone number of a person to whom the gift is to be sent. In this view, screen 301 indicates a mode for requesting a recipient's identifier “Enter phone no.,” as indicated by reference number 303. User 102 may enter or input the recipient's phone number at field space 306. It should be understood that, other than a recipient's phone number, other suitable recipient identifiers may be used, for example, a recipient's password, identification number, code, name, address, driver's license number, or any other suitable identifier.

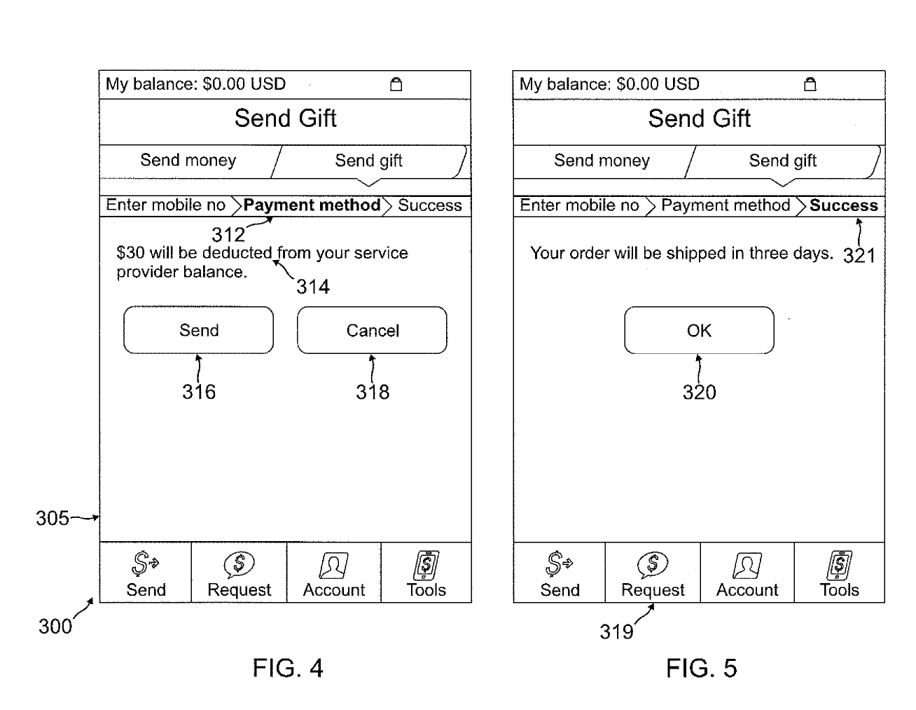

Once user 102 enters and reviews the information on screen 301, user 102 may proceed by selecting input 308 labeled as “Send” to proceed, for example, to a mode or stage for making payment. Referring now to FIG. 4, screen 305 of interface 300 illustrates a view of a mode or stage labeled “Payment method” as indicated by reference numeral 312. Screen 305 shows the total amount to user 102 for confirmation. According to one or more embodiments, one payment option may include deducting the total amount from the user's account maintained at a service provider. As such, screen 305 illustrates an example showing the total amount as well as the payment method at reference numeral 314 “$30 will be deducted from your service provider balance.”

It should be understood that numerous methods of payments may be used including, for example, charging or deducting funds from any financial institution or from a transaction card such as a credit card, a debit card, or a gift card, or from a checking account, a savings account, an investment account, or from any other suitable funding sources.

In this embodiment of FIG. 4, upon review, user 102 may cancel the gift transaction by selecting an input 318 labeled as “Cancel”. Alternatively, by selecting an input 316 labeled as “Send”, funds will be debited from the user's service provider balance for payment in connection with the gift transaction.

Referring to FIG. 5, a screen 319 illustrates a view of the process in a “Success” mode or stage as indicated by reference numeral “321” indicating that the gift transaction was successful. User 102 may acknowledge the gift transaction by selecting input “320”.

It should be understood that any suitable labels may be used for the inputs, modes or stages illustrated in FIGS. 3-5 herein according to one or more embodiments. Also, it should be understood that there are numerous ways to enter or input data or information into screens 301, 305 or 319 of user interface 300 as known in the art including, for example, by pressing a button, or using a keyboard, a touchscreen, voice recognition, or any other type of input device.

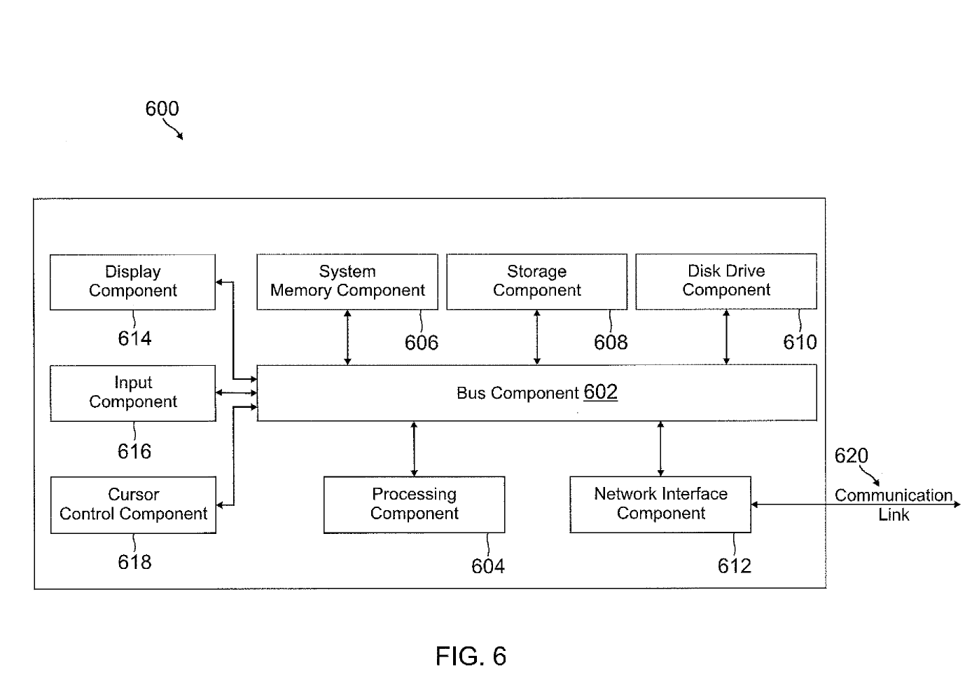

FIG. 6 is a block diagram of a system 600 suitable for implementing embodiments of the present disclosure, including client device 120, one or more merchant servers or devices 140, and service provider server or device 180. System 600, such as part of a cell phone, smart phone, personal computer and/or a network server, includes a bus 602 or other communication mechanism for communicating information, which interconnects subsystems and components, including one or more of a processing component 604 (e.g., processor, micro-controller, digital signal processor (DSP), etc.), a system memory component 606 (e.g., RAM), a static storage component 608 (e.g., ROM), a network interface component 612, a display component 614 (or alternatively, an interface to an external display), an input component 616 (e.g., keypad or keyboard), and a cursor control component 618 (e.g., a mouse pad).

In accordance with embodiments of the present disclosure, system 600 performs specific operations by processor 604 executing one or more sequences of one or more instructions contained in system memory component 606. Such instructions may be read into system memory component 606 from another computer readable medium, such as static storage component 608. These may include instructions to proactively conduct marketing campaigns through communications to one or more user devices, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 604 for execution. Such a medium may take many forms, including but not limited to, non-volatile media, volatile media, and transmission media. In one embodiment, the computer readable medium is non-transitory. In various implementations, volatile media includes dynamic memory, such as system memory component 606, and transmission media includes coaxial cables, copper wire, and fiber optics, including wires that comprise bus 602. Memory may be used to store user data, transaction information, business entity networks and/or products, etc. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 600. In various other embodiments, a plurality of systems 600 coupled by communication link 620 (e.g., network 160 of FIG. 1, LAN, WLAN, PTSN, or various other wired or wireless networks) may perform instruction sequences to practice the disclosure in coordination with one another. Computer system 600 may transmit and receive messages, data, information and instructions, including one or more programs (i.e., application code) through communication link 620 and communication interface 612. Received program code may be executed by processor 604 as received and/or stored in disk drive component 610 or some other non-volatile storage component for execution.

In view of the present disclosure, it will be appreciated that various methods and systems have been described according to one or more embodiments for conducting transactions involving sending gifts over a client device with minimal key entries.

Although various components and steps have been described herein as being associated with client device 120, merchant server 140, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

What is claimed is:

1. A method for gift transactions comprising:
receiving, by a server at a remote location, from a user via a client device, an order selecting one or more items and/or services to be sent to a recipient along with a recipient's identifier that is entered by the user on the client device, wherein the recipient's identifier is used to determine delivery information of the recipient;
sending, by the server at the remote location, the recipient's identifier to a merchant server for fulfillment of the order; and
receiving, by the server at the remote location, confirmation of the order from the user via the client device.

2. The method of claim 1, further comprising sending to the user having the client device, by the server at the remote location, a communication providing a selection of one or more items and/or services to be sent to the recipient.

3. The method of claim 2, wherein the sending the communication further comprises sending suggested customized items and/or services appropriate for specific special occasions.

4. The method of claim 2, wherein the sending the communication further comprises sending, by the server at the remote location, an SMS text communication, an email communication or a pop-up window on the client device.

5. The method of claim 1, wherein the receiving the order further comprises receiving an order selecting one or more items and/or services that are kept as favorites by the user on the client device.

6. The method of claim 1, wherein the receiving the recipient's identifier further comprises receiving a phone number of the recipient that is used by the server at the remote location or the merchant server to obtain the recipient's delivery information.

7. The method of claim 1, wherein the recipient's delivery information further comprises the recipient's name and shipping information.

8. The method of claim 1, further comprising maintaining a user account at the server at the remote location and debiting the user's account for an amount corresponding to the fulfillment of the order.

9. The method of claim 1, wherein the server at the remote location further comprises a server of a payment service provider.

10. A gift system comprising:
a payment provider server in communication with a client device and a merchant server over a network;
one or more processors; and
one or more memories adapted to store a plurality of machine-readable instructions which when executed by the one or more processors are adapted to cause the gift system to:
receive, by the payment provider server, an order selecting one or more items and/or services from a user over the client device to be sent to a recipient along with a recipient's identifier that is entered by the user on the client device, wherein the recipient's identifier is used to determine delivery information of the recipient;
send, by the payment provider server, the recipient's identifier to a merchant server for fulfillment of the order; and
receive, by the payment provider server, confirmation of the order from the user via the client device.

11. The gift system of claim 10, wherein the recipient's identifier further comprises a phone number of the recipient that is used by the payment provider server or the merchant server to obtain the recipient's delivery information.

12. The gift system of claim 10, wherein the recipient's delivery information further comprises the recipient's name and shipping information.

13. The gift system of claim 10, wherein the plurality of machine-readable instructions which when executed by the one or more processors are further adapted to cause the gift system to: maintain, by the payment provider sever, a user account for the user and debit the user's account for an amount corresponding to the fulfillment of the order.

14. The gift system of claim 10, wherein the plurality of machine-readable instructions which when executed by the one or more processors are further adapted to cause the gift system to: send, by the payment provider sever, suggested customized items and/or services appropriate for specific special occasions to be sent by the user over the client device to the recipient.

15. The gift system of claim 10, wherein the order further comprises one or more items and/or services kept as favorites by the user on the client device.

16. A client device comprising:
a user interface;
a gift application loaded in the client device from a service provider server;
one or more processors; and
one or more memories adapted to store a plurality of machine-readable instructions which when executed by the one or more processors are adapted to cause the client device to:
receive, via the user interface, inputs for a gift transaction comprising selection of one or more items and/or services to be sent to a recipient as a gift and a recipient's identifier, wherein the recipient identifier is used to determine delivery information of the recipient;
transmit information of the gift transaction to a payment provider server, wherein the payment provider server sends the recipient's identifier to a merchant server for fulfillment of the gift transaction; and
confirm the information of the gift transaction.

17. The client device of claim 16, wherein the information of the gift transaction further comprises a payment amount, the selection of the one or more items and/or services and the recipient's delivery information.

18. The client device of claim 16, wherein the machine-readable instructions when executed by the one or more processors are further adapted to receive, from the payment provider server, a communication to send an item and/or service as a gift to the recipient.

19. The client device of claim 16, wherein the machine-readable instructions when executed by the one or more processors are further adapted to select an item and/or service stored as favorites on the client device.

20. The client device of claim 16, wherein the machine-readable instructions when executed by the one or more processors are adapted to cause the client device to pass a user identifier with payment information to the service provider server.

21. A non-transitory computer readable medium on which are stored computer readable instructions and, when executed by a processor, cause the processor to:
receive, by a payment provider server, an order selecting one or more items and/or services from a user over a client device to be sent to a recipient along with a recipient's identifier that is entered by the user on the client device, wherein the recipient's identifier is used to determine delivery information of the recipient;
send, by the payment provider server, the recipient's identifier to a merchant server for fulfillment of the order; and
receive, by the payment provider server, confirmation of the order from the user via the client device.
